(19) United States
(12) Patent Application Publication
(10) Pub. No.: US 2003/0041160 A1
(43) Pub. Date: Feb. 27, 2003

(54) Methods and systems for reducing command overhead

(76) Inventors: Robert James Sandman, Syracuse, UT (US); Troy Taylor Davidson, Clinton, UT (US); Don Earl Redford, Layton, UT (US)

Correspondence Address: DINSMORE & SHOHL, LLP, 1900 CHEMED CENTER, 255 EAST FIFTH STREET, CINCINNATI, OH, 45202, US

(21) Appl. No.: 09/934,405

(22) Filed: Aug. 21, 2001

(51) Int. Cl. G06F 15/16

(52) U.S. Cl. 709/231

(57) ABSTRACT

Methods and systems are provided for reducing the overhead associated with media commands issued to computing devices. A request is received from an application to access a device, and a single media present command is issued to a device driver to determine if media is present in the device. The request is passed to the device driver only if media is present in the device. Moreover, a method of intercepting commands issued to a device driver, is provided wherein a call is received from an application which is intended for a device driver, the call is buffered until media is present in a device whereupon the call is released to the device driver for processing.

Furthermore, a system for communication between a primary computing device and an ancillary computing device is provided, including a communication channel operable to interface the primary device to the ancillary device. A device interface set of executable instructions residing on the primary device receives access commands and prevents the commands from being transferred to the ancillary device until media is determined to be present in the ancillary device.

### FIELD OF THE INVENTION

The present invention relates to methods and systems for reducing the command overhead associated with media access commands to peripheral computing devices.

### BACKGROUND OF THE INVENTION

Currently under some operating system environments, such as and by way of example only MICROSOFT WINDOWS, when multiple devices are connected to a Universal Serial Bus (“USB”) the main computing device's processor slows down or idles considerably, while the main computing device attempts to access devices which may not have media actually inserted or attached to the devices. Access is typically made through a series of read or write commands transmitted over the USB to the devices.

WINDOWS as well as other utilities or applications scan devices connected to the main computing device via an USB, each scan operation may include many media access commands which clutter the USB and increase latency on the main computing device. This latency will make even a powerful desktop computing device having a 1 gigahertz (“GHz”) processor appear sluggish or otherwise unresponsive. However, often the multiple media access commands are unnecessary since no media is actually present or attached to the scanned device. Still, the utilities or applications must wait until all media access commands complete before an error condition is returned and the utility or application is permitted to proceed with processing normally.

As one skilled in the art will readily appreciate, the ability to reduce this traffic on the USB will improve the overall performance and increase the throughput of the utilities or applications. Moreover, in environments where multiple devices are in concurrent communication with a main computing device and share the same USB, a reduction in USB data traffic can improve the data quality and the performance of the devices.

For example, consider a Web camera sharing an USB with a mass storage device, such as a ZIP drive, with the Web camera in operation and actively recording the images of a computer operator sitting in front of the Web camera's lens. Concurrently, if an editing application attempts to write a large file to the ZIP drive, the images being captured by the Web camera may appear to experience static or become blurry because of the increased traffic occurring with the media access commands, thereby cluttering the USB while attempts are made to write data to the ZIP drive.

However, the quality of the Web camera need not be impacted if the ZIP drive has no media inserted or attached, since a single command could indicate the drive is empty, and transporting the entire file to the ZIP drive is pointless and merely serves to interfere with data traffic on the USB and degrade overall performance of both the Web camera software and the editing software residing on the desktop computer.

It is frustrating and annoying to computer operators when they are forced to wait on an application which issues a request to access a device drive, when the device has no media attached or inserted, especially if the application request could have been readily rejected at the outset by a single media check, rather than forcing the application to idle while the entire request and any accompanying data are transferred to the device before control is returned to the calling application with the appropriate error message.

Moreover, as one skilled in the art will appreciate access to non existent memory is problematic not only for multiple devices sharing the same USB but for all devices in communication with the main computing device. For example, consider a diskette drive often attached as an internal drive to a main computing device and identified as the “A” drive. Often, when a word processor or editing application is shut down while a file was being edited from the “A” drive, the editing application will remember this location and when opened a second time, the editing application idles while the “A” drive is scanned multiple times looking for media. During this period of time, the computer operator hears the “A” drive being accessed and realizes what is transpiring but is helpless to stop the operation until, it completes entirely. However, when the editing application was executed a second time, if an indication could be made immediately to the editing application that no media existed in the “A” drive, then with little lag time the editing application could return to normal operation with no noticeable delay experienced by the operator, and the annoying sound affects could be avoided altogether.

As a result, more efficient access to peripheral devices having removable media and in communication with a main computing device are needed, such that bus traffic and command processing overhead is reduced resulting in improved application performance, data reliability, and operator satisfaction.

### SUMMARY OF THE INVENTION

Accordingly, an object of the invention is to provide methods and systems for reducing command overhead processing associated with media access commands to peripheral computing devices. Initially, an application requests access to a media associated with a peripheral device, the peripheral device is in communication with a computing device running the application. Typically, the request is processed by a device driver residing on the computing device, however, this control is interrupted and the request is intercepted before the device driver can process the request.

A single command is then issued to the device driver to check for media in the peripheral device. If media is not present in the peripheral device then the request to access the peripheral device is not forwarded along to the device driver. In this way, the communication channel between the computing device and the peripheral device is efficiently used and command traffic associated with attempts to access non existent media in the peripheral device is significantly reduced. Moreover, the reduction in command traffic on the communication channel will improve the data quality of data being simultaneously transmitted, for other unrelated purposes, on the communication channel.

Additional objectives, advantages and novel features of the invention will be set forth in the description that follows and, in part, will become apparent to those skilled in the art upon examining or practicing the invention. The objects and advantages of the invention may be realized and obtained by means of the instrumentalities and combinations particularly pointed out in the appended claims. To achieve the foregoing and other objects and in accordance with the purpose of the present invention, methods and systems for reducing command overhead are provided.

In one aspect of the present invention, a method of communicating with computing devices having executable instructions is provided, wherein a request is received from an application to access a device and a single media present command is issued to a device driver to determine a value associated with a media present flag. The device driver returns the media present flag and if the flag is set to true, the request is passed to the device driver for further processing.

In another aspect of the present invention, a method of intercepting commands issued to a device driver having executable instructions is provided, wherein a call is received, which is intended for a device driver and issued from an operating system application. The call is buffered and withheld from the device driver, until media is present in a device, whereupon the call is released to the device driver for resolution.

In yet another aspect of the present invention, a system for communication occurring between a primary computing device and an ancillary computing device is provided including a communication channel operable to interface the primary device to the ancillary device. Moreover, a device interface set of executable instructions is operable to receive access commands from an application and withhold the commands from being transferred to the communication channel and the ancillary device until a media is determined to be present in the ancillary device.

Still other aspects of the present invention will become apparent to those skilled in the art from the following description of an exemplary embodiment, which is by way of illustration, one of the exemplary modes contemplated for carrying out the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIG. 1 depicts one method of communicating with computing devices;

FIG. 2 depicts one method of intercepting commands issued to a device driver; and

FIG. 3 depicts a schematic diagram of a system of communication between a primary computing device and ancillary devices.

### DETAILED DESCRIPTION

The present invention provides methods and systems for reducing command overhead associated with media commands issued to peripheral devices. One embodiment of the present invention is implemented using the C and Assembly programming languages for processors running the MICROSOFT WINDOWS/NT operating system. Of course other programming languages and operating systems (now known or hereafter developed) may also be readily employed without departing from the present invention.

Application programs frequently need to access external media housed in an external device. Often the external device shares a communication line with additional external devices. By way of example only and as previously presented, consider a ZIP storage device in communication with a standard personal computing (“PC”) device. The communication may be achieved via a USB directly connected to both the PC and the ZIP device. Moreover, the USB may also interface and connect additional devices such as a Web camera.

Furthermore, if the Web camera is in operation while access to the ZIP device is desired, performance of the Web camera operation and of the ZIP device may be compromised, particularly when access to media associated with the ZIP drive is requested from an application program residing on the PC. Moreover, in a standard access request a device driver application associated with the ZIP device will receive the application program's request and pass/translate all the commands and data associated with the request directly to the USB and ultimately the external ZIP device. This is done before a determination is made as to whether there is actual media present in the ZIP device so as to make the request useful. If no media is present then each command may cause a useless scan of the ZIP device and unnecessary traffic on the USB, since each command is destined to fail with no media present in the ZIP drive.

It is also likely that the application will not be notified that media is missing from the ZIP device until all commands and associated data fail on the ZIP device for lack of media being present. At that point in time, a fail command is returned to the device driver where an appropriate message is communicated to the application, or independent of the application via a notification to a user through a popup window or the like.

As will be readily apparent to one skilled in the art, situations similar to the one presented above occur with some regularity while operating various applications on a computing device. It is frustrating to hear external devices, or even devices attached via internal buses such as diskette drives, needless be accessed and an application idle for a few seconds to a few minutes until control is returned to the user/operator. Of course, the user/operator instantly recognizes his/her mistake or the application's mistake but is generally helpless to terminate the wasted traffic on the communication channel or decrease the idle state of the application until all commands and data fail on the device.

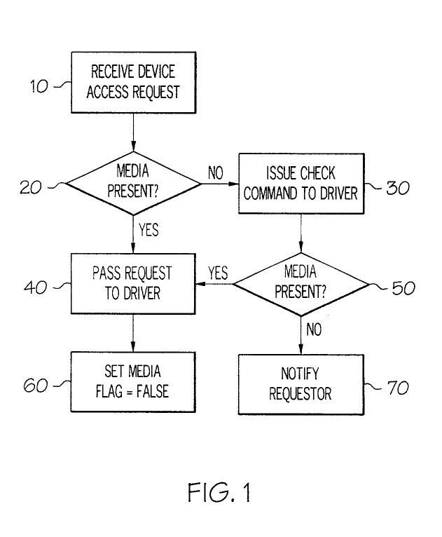

Accordingly, FIG. 1 depicts one method of communicating with computing devices. Initially, a request to access a device is received in step 10. Receipt of the request may occur through a variety of methods, such as a set of executable instructions serving as a wrapper around a device driver of a device, executable instructions independent of any application or device driver, executable instructions integrated into an application or a device driver, and the like.

The receiver of the request to access a device, buffers all commands and data intended for the device, and issues a single media present command in step 20 to the device driver of the device in step 30 or alternatively to the device directly (not shown). The purpose of the media present command is to check for media in the device before release all the buffered commands and data to the communications channel and ultimately the device. In this way, should no media be present the commands and data will not needlessly clutter the communications channel, which as presented before may be shared by multiple devices such as in the case where two or more devices share a USB. However, even devices not sharing a communication channel with a computing device will benefit from the present invention, since the latency associated with transmitting all commands and data to the device may be avoid where it is apparent that media is not present in the device.

In step 20, if a media present flag is already set (e.g., value is equal to 1 or true) then there would be no need to send a media present flag since the media would be present already, and in these instances the commands and data associated with a device access request may be passed directly to the device driver or the device directly as the case may be (step 40). However, if the media present flag is not set (e.g., value is set to 0 or false) then a media access command will need to me made in step 50. Whereupon, if media is present the commands and data associated with the request are passed along in step 40.

If media is not present upon receiving a response to an issued media present command, then notification is communicated to the requestor in step 70 without sending all the commands and data associated with the request to access the device over the communications channel. Moreover, if media was present in the device, then after successfully sending the command and data to the device for execution, the media present flag may be optionally unset (e.g., set to 0 or false). In this way, a single media present command will issue to the device driver or device on each independent request made to access the device. This will ensure that media is not removed from the device after an initial request without the media present flag being appropriately set.

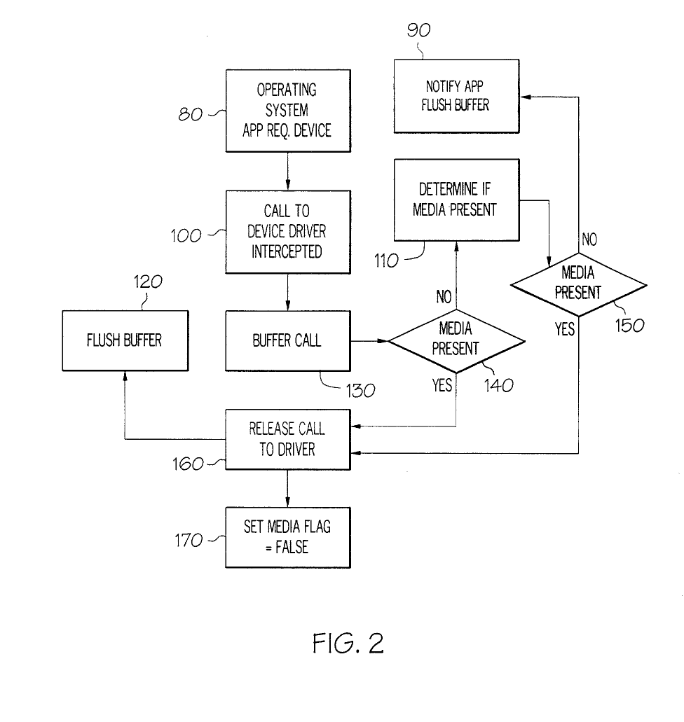

FIG. 2 depicts one method of intercepting commands issued to a device driver. An operating system application requests access to a device in step 80, at which time a call is issued to a device driver associated with the device to initiate a dialogue with the device being requested. The call made to the device driver is intercepted in step 100, and the entire call issued by the application to the device is buffered in step 130 until a determination is made as to whether media is present in step 140.

Media present in the device driver will cause the entire buffered call made by the application to be released for processing to the device driver in step 160, resulting in the buffer being flushed in step 120. Moreover, a media flag used to identify whether media is present in the device is set to false (step 170) upon successfully concluding the processing associated with the application's call to the device.

If the media flag is not set to true, then a single command is issued to the device driver in step 110 to determine in step 110 whether media is present in step 150. As one skilled in the art will readily appreciate the expense associated with a single command checking the device to determine whether media is present is extremely low relative to the expense associated with transferring an entire access call issued from the application to the device via the device driver, wherein the call may include many data access commands to media which is not present in the device. If the single command returns a media present flag which is not set to true then notification is made to the issuing application in step 90 that no media is present and the buffer is flushed. However, if the media flag is set to true after the single command is issued, then the entire application call is released to the device driver for processing in step 160, with the buffer being flushed in step 120. Upon conclusion of the call, the media present flag is set to false in step 170.

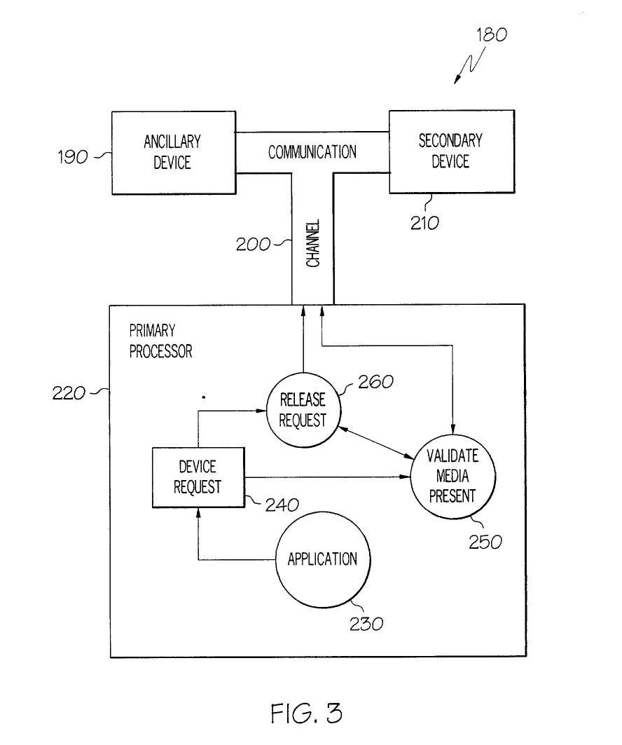

FIG. 3 depicts a schematic diagram of a system 180 of communication between a primary computing device 220 and ancillary devices 190 210. System 180 includes a communication channel 200, ancillary device 190, optionally one or more secondary devices 210, and a primary processor 220 having a device interface set of executable instructions, wherein a device request is received in step 240 from an application 230. Moreover, the device request is first checked to determine if media is present in step 250 before the request is fully released in step 260 to the communication channel 200 and the ancillary device 190.

The primary processor 220 may be any computing device, such as a standard personal computer, a hand held computing device, an intelligent appliance with processor capabilities, a digital phone, and the like. Furthermore, the communication channel 200 may be any communication channel such as a USB, a Blue Tooth wireless communication, an 802.11 wireless communication, any direct communication connection, any wireless communication connection, and others.

Furthermore, a device set interface set of executable instructions is operable to receive a request for a device as depicted in step 240, to validate whether media is present as depicted in step 250, and further operable to release a request in step 260 if media is determined to be present. As one skilled in the art will appreciate, the device interface set of executable instructions may exist as a standalone program, as a coupled or integrated function of an application program, as a wrapper to a set of device driver executable instructions, and the like. Further, the interface set of executable instructions may be slightly modified versions of existing interfaces, such as and by way of example only IEEE 1394 interfaces, SCSI interfaces, ATA interfaces, ATAPI interfaces, and other interfaces.

Moreover, although not depicted in FIG. 3 if media is determined to not be present in an ancillary device 190, then the device interface set of executable instructions may be further operable to notify the application 230 of this error state, so the application 230 may continue processing without remaining idle awaiting all commands and data associated with the application's 230 initial request to pass through the communication channel 200 to the ancillary device 190 and fail, since media will be absent from the ancillary device 190.

The foregoing description of an exemplary embodiment of the invention has been presented for purposes of illustration and description. It is not intended to be exhaustive nor to limit the invention to the precise form disclosed. Many alternatives, modifications, and variations will be apparent to those skilled in the art in light of the above teaching. Accordingly, this invention is intended to embrace all alternatives, modifications, and variations that fall within the spirit and broad scope of the attached claims.

What is claimed:

1. A method of communicating with computing devices, having executable instructions comprising:
receiving a request from an application to access a device;
issuing a single media present command to a device driver of the device, if a media present flag is set to false; and
receiving the media present flag from the device driver and passing the request to the device driver if the media present flag is set to true.

2. The method of claim 1, further comprising:
blocking the device driver's access to the request until the media present flag is set to true.

3. The method of claim 1, further comprising:
setting the media present flag to false after the request completes.

4. The method of claim 1, wherein the request includes at least one of one or more read commands associated with a media in the device and one or more write commands associated with data to write to the media.

5. The method of further comprising:
notifying the application if the received media present flag is set to false.

6. The method fo claim 1, wherein the application resides on a first computing device and the device is in communication with the first computing device via a Universal Serial Bus.

7. The method of claim 6, wherein the device shares the Universal Serial Bus with one or more second devices.

8. A method of intercepting commands issued to a device driver, having executable instructions comprising:
receiving a call intended for a device driver from an operating system application;
buffering the call until a media present flag is set; and
releasing the call to a device driver for resolution if the media present flag is set to true.

9. The method of claim 8, further comprising:
notifying the operating system application if the media present flag is set to false.

10. The method of claim 9, further comprising deleting the buffered call.

11. The method of claim 8, further comprising:
setting the media present flag to false once the call is completely released to the device driver when the media present flag is set to true.

12. The method of claim 8, wherein the call includes one or more instructions to the device driver.

13. The method of claim 8, wherein the call shares a communication channel with one or more second calls.

14. The method of claim 13, wherein the communication channel is a Universal Serial Bus.

15. The method of claim 14, wherein the call is not present in the Universal Serial Bus until released to the device driver, if at all.

16. A system for communication between a primary computing device and an ancillary computing device, comprising:
a communication channel operable to interface a primary computing device to an ancillary computing device; and
a device interface set of executable instructions residing on the primary computing device and operable to receive one or more access commands from an application residing on the primary computing device and further operable to prevent the commands from being transferred to the communication channel and the ancillary computing device until a media is determined to be present in the ancillary computing device.

17. The method of claim 16, wherein the communication channel is a Universal Serial Bus.

18. The method of claim 16, wherein the communication channel is further operable to interface the primary computing device to one or more secondary computing devices.

19. The method of claim 16, wherein the ancillary device is a mass storage device.

20. The method of claim 16, wherein a single check media command is sent by the device interface set of executable instructions to the ancillary device over the communication channel to determine if the media is present.
